(19) United States
(12) Patent Application Publication
(10) Pub. No.: US 2014/0118207 A1
(43) Pub. Date: May 1, 2014

(54) ANTENNA ASSEMBLY

(71) Applicant: CHIUN MAI COMMUNICATION SYSTEMS, INC., New Taipei (TW)

(72) Inventors: TZE-HSUAN CHANG, New Taipei (TW); CHO-KANG HSU, New Taipei (TW)

(73) Assignee: CHIUN MAI COMMUNICATION SYSTEMS, INC., New Taipei (TW)

(21) Appl. No.: 14/019,683

(22) Filed: Sep. 6, 2013

(30) Foreign Application Priority Data
Oct. 31, 2012 (TW) 101140224

(51) Int. Cl. H01Q 13/10

(52) U.S. Cl. CPC H01Q 13/10
USPC 343/767

(57) ABSTRACT

An antenna assembly of very small size includes a base board, a ground plane, a feed portion, and a radiating portion. The base board includes a first surface and a second surface opposite to the first surface. The ground plane is positioned on the first surface and configured to provide ground for the antenna assembly. One end of the feed portion is attached to the second surface and is extended to the first surface with another end of the feed portion attached to the first surface. The radiating portion is formed by exposing portions of the ground plane and coupling the removed portion with the feed portion to form a slot antenna.

### BACKGROUND

1. Technical Field

The disclosure generally relates to antennas, and particularly to a wideband antenna assembly having a reduced size.

2. Description of Related Art

In wireless communication devices such as mobile phones and personal digital assistants, antenna devices to transmit and exchange radio data by transmitting and receiving electromagnetic waves are an essential element.

To realize a suitability of wireless communication devices for different communication systems, wideband antenna are used to allow transmission and receiving of multiple frequency bands for different communication systems. However, many wideband antennas have complicated structures and large sizes, making it difficult to miniaturize portable electronic devices.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of an antenna assembly, according to an exemplary embodiment of the disclosure.

FIGS. 2A-2C are plan schematic views of feed portions, according to other exemplary embodiments of the disclosure.

FIGS. 3A-3C are plan schematic views of radiating portions, according to other exemplary embodiments of the disclosure.

FIG. 4 is a schematic view of dimensions of one embodiment of a feed portion and a radiating portion.

FIG. 5 is a diagram showing return loss (RL) measurements of the antenna assembly of FIG. 1.

FIG. 6 is a diagram showing efficiency measurement of the antenna assembly of FIG. 1.

### DETAILED DESCRIPTION

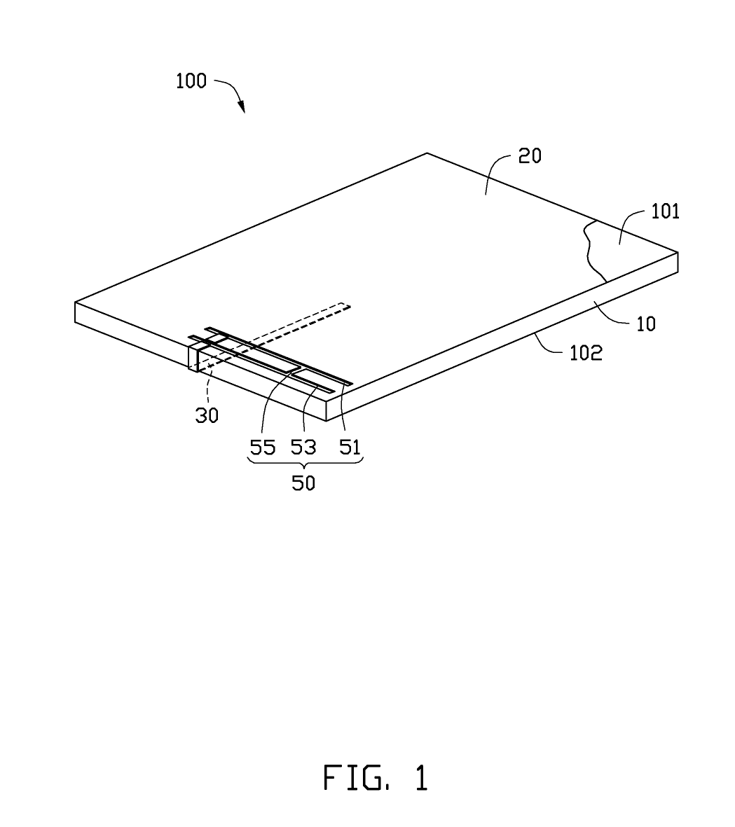

FIG. 1 shows an antenna assembly 100, according to an exemplary embodiment of the disclosure. The antenna assembly 100 is used in a wireless communication device such as mobile phone. The antenna assembly 100 includes a base board 10, a ground plane 20, a feed portion 30, and a radiating portion 50.

The base board 10 is made of dielectric material such as epoxy resin glass fiber. In this embodiment, the dielectric coefficient of the dielectric material is εᵣ. The base board 10 is substantially a flat board including a first surface 101 and a second surface 102 parallel and opposite to the first surface 101.

The ground plane 20 is positioned on the first surface 101 and configured to provide ground for the antenna assembly 100. In this embodiment, the ground plane 20 is a layer of conductive foil, such as copper foil, plated on the first surface 101.

In this embodiment, the feed portion 30 is a microstrip line. A first end of the feed portion 30 is attached to the second surface 102 and extends to the first surface 101 with a second end of the feed portion 30 attached to the first surface 101. The first end of the feed portion 30 is electrically connected to a radio frequency (RF) circuit positioned inside the wireless communication device and configured to obtain current from the RF circuit to transmit radio signals. The second end of the feed portion 30 partially overlaps the ground plate 20. In this embodiment, the feed portion 30 is a strip-shaped body of even width. In addition, the width, length, and the shape can be adjusted to make the antenna assembly 100 have a maximal bandwidth.

The radiating portion 50 is formed on the ground plane 20 by removing a portion of the ground plane 20 (i.e. the layer of the conductive foil on the base board 10 to expose the dielectric material of the base board 10) and forming a slot antenna. The radiating portion 50 includes a first exposed dielectric portion 51, a second exposed dielectric portion 53, and a third exposed dielectric portion 55. In this embodiment, the first exposed dielectric portion 51 and the second exposed dielectric portion 53 are parallel and oppositely positioned strips. The third exposed dielectric portion 55 is also a strip and positioned between the first exposed dielectric portion 51 and the second exposed dielectric portion 55 with two ends of the third exposed dielectric portion 55 perpendicularly connected to the first exposed dielectric portion 51 and the second exposed dielectric portion 53. The first exposed dielectric portion 51, the second exposed dielectric portion 53, and the third exposed dielectric portion 53 form a substantially H-shaped closed structure.

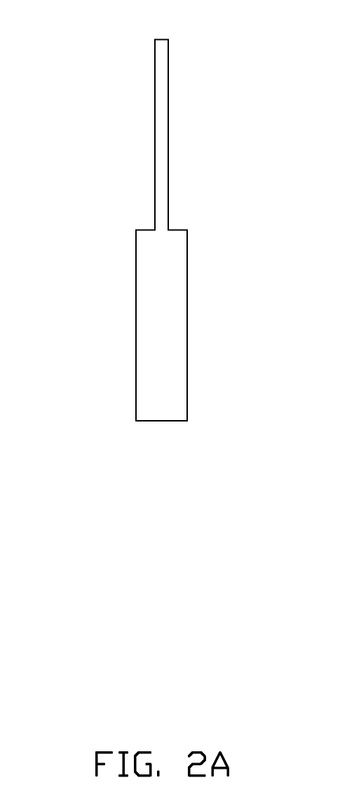

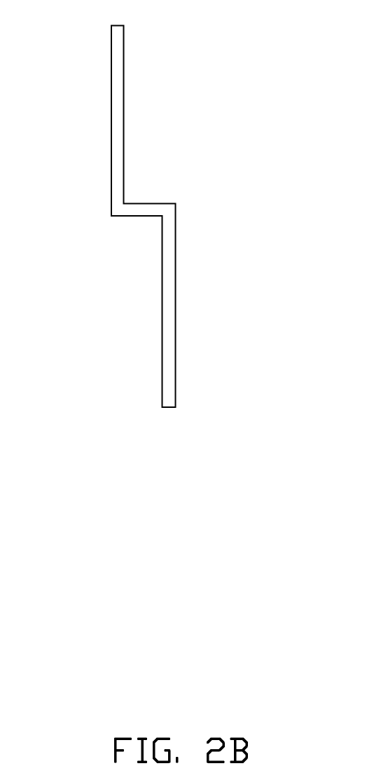

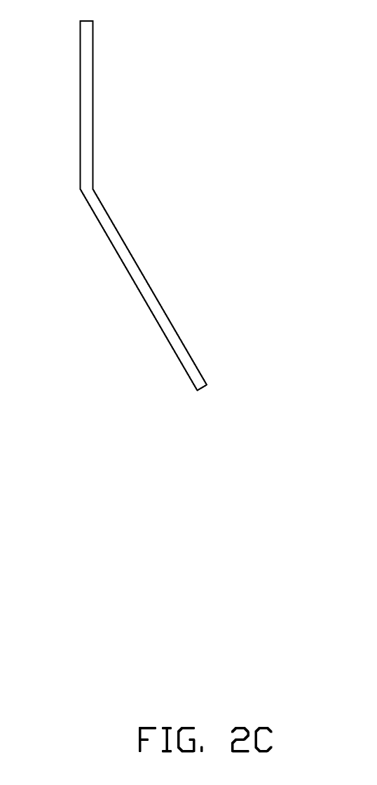

Referring to FIGS. 2A-2C, in other embodiments, the feed portion 30 may be strip-shaped and have an uneven width (shown in FIG. 2A), or have a curved shape (shown in FIGS. 2B and 2C).

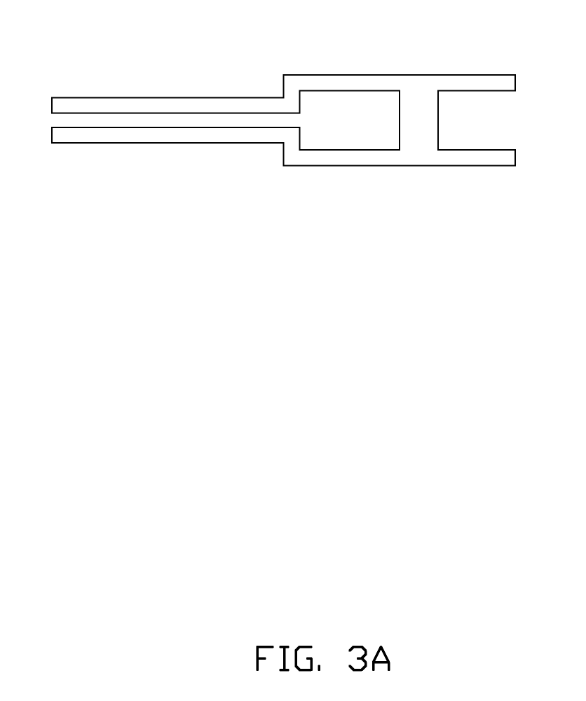

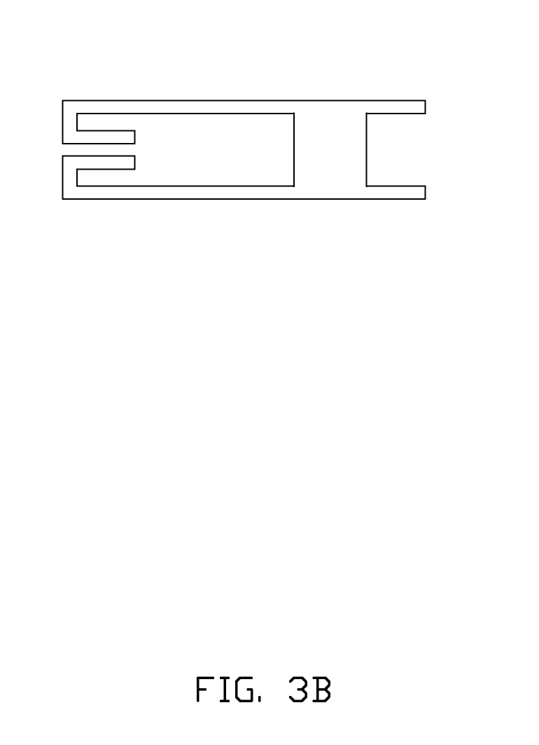

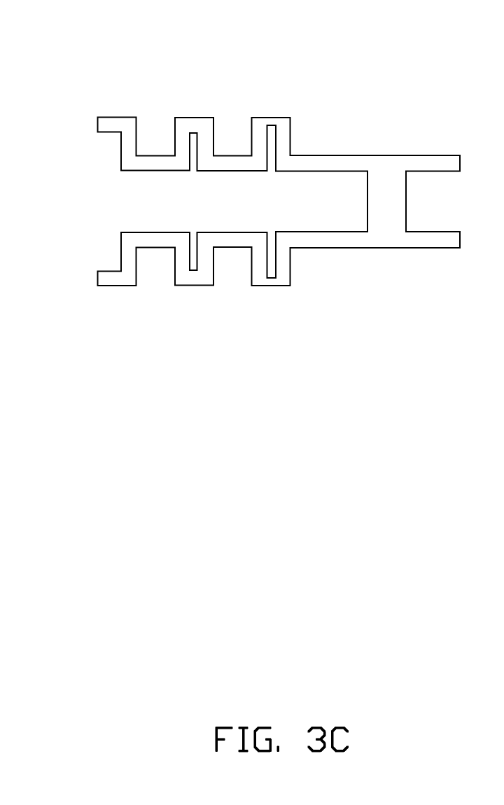

Referring to FIGS. 3A-3C, in other embodiments, the radiating portion 50 may be other structures, so long as the first exposed dielectric portion 51, the second exposed dielectric portion 53, and the exposed dielectric portion 53 still have the H-shaped closed structure. For example, two ends of the first exposed dielectric portion 51, the second exposed dielectric portion 53 have a bent shape (shown in FIGS. 3A and 3B) or a zigzag shape (shown in FIG. 3C); the third exposed dielectric portion 55 is still strip-shaped.

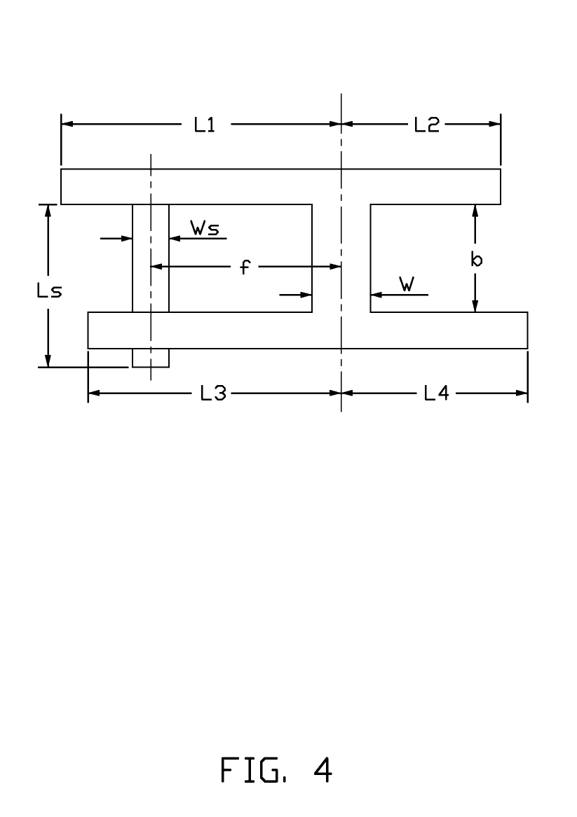

Referring to FIG. 4, the width of the feed portion 30 is defined as Ws. A length of a portion of the feed portion 30 attached on the ground plane 20 is defined as Ls. A distance between the portion of the feed portion 30 attached on the ground plane 20 and the third exposed dielectric portion 55 is defined as f. A length and width of the third exposed dielectric portion 55 are defined as b and w. The antenna assembly 100 can work at a first frequency band, a second frequency band, and a third frequency band by adjusting a first group of parameters which comprise Ws, Ls, f, b, and w.

In addition, a distance between the third exposed dielectric portion 55 and one end of the first exposed dielectric portion 51 is defined as L1. A distance between the third exposed dielectric portion 55 and one end of the second exposed dielectric portion 53 is defined as L3. A distance between third exposed dielectric portion 55 and another end of the second exposed dielectric portion 53 is defined as L4. Bandwidths of the first frequency band, the second frequency band, and the third frequency band of the antenna assembly 100 can be adjusted by changing a second group of parameters which comprise Ws, Ls, f, b, and w. Specifically, a first central frequency fᵣ₁, a second central frequency fᵣ₂, and a third central frequency fᵣ₃ corresponding to the first frequency band, the second frequency band, and the third frequency band satisfy formulas (1)-(3):

$$\begin{matrix}{f}_{r 1} = \frac{c}{2 {ɛ}_{eff} ( L 1 + L 2 )} & ( 1 ) \\ {f}_{r 2} = \frac{c}{{ɛ}_{eff} ( L 1 + L 2 + L 3 + L 4 )} & ( 2 ) \\ {f}_{r 3} = \frac{2.5 c}{{ɛ}_{eff} ( L 1 + L 2 + L 3 + L 4 )} & ( 3 )\end{matrix}$$

Wherein, c and ε_{eff} represent speed of light and dielectric coefficient, and satisfy formula (4):

$${ɛ}_{eff} = \sqrt{\frac{1 + {ɛ}_{r}}{2}} \qquad ( 4 )$$

In use, the signals are fed into the feed portion 30 and obtain different paths for the flow of current by the feed portion 30 and the radiating portion 50, to generate different signals so that the antenna assembly 100 can enter a resonance mode at the first central frequency about 1.575 GHz, at the second central frequency about 2.4 GHz, and at the third central frequency about 5.2 GHz, and work effectively in the first frequency band, the second frequency band about 2.38 GHz-2.834 GHz, and the third frequency band about 4.66 GHz-6.3 GHz.

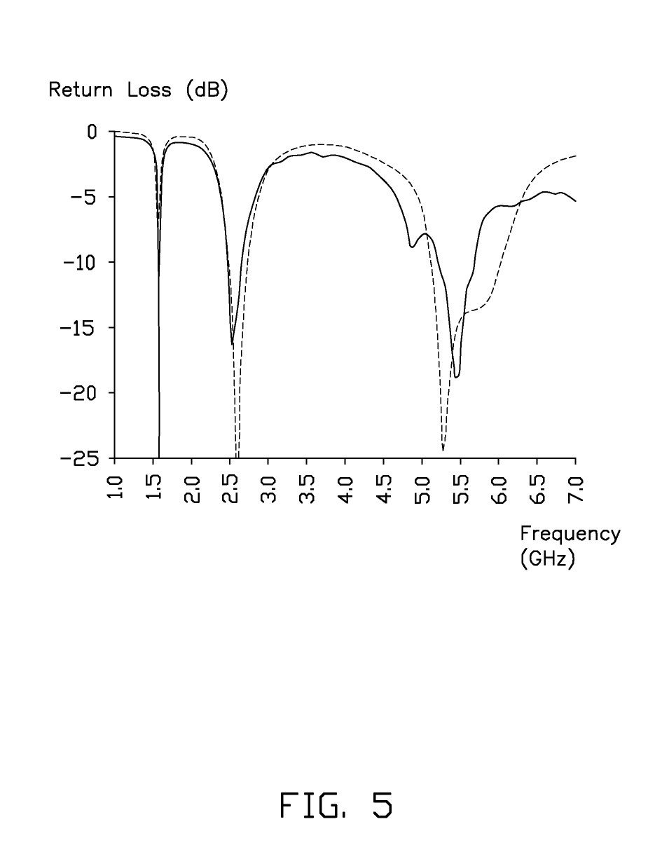

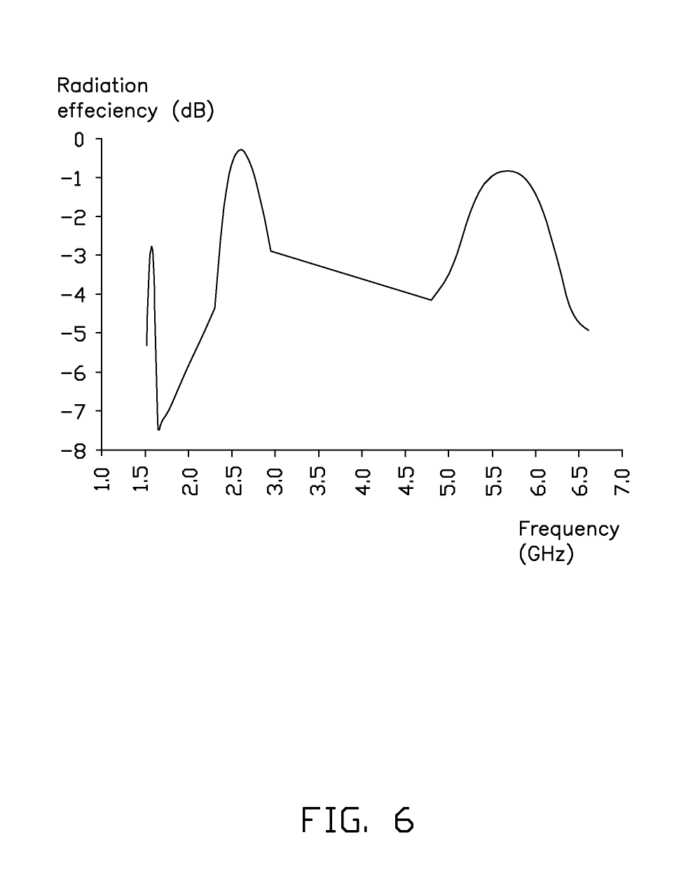

Referring to FIGS. 5 and 6, in one embodiment, when h=0.7 mm, εr=4.2, Ws=2 mm, w=2.9 mm, b=3 mm, Ls=5.6 mm, f=29.2 mm, L1=34.5 mm, L2=7 mm, L3=29.6 mm and L4=7 mm, the antenna assembly 100 can obtain the first frequency band about 1.555 GHz-1.611 GHz, the second frequency band about 2.38 GHz-2.834 GHz and third frequency band about 4.66 GHz-6.3 GHz and have better radiation efficiency in all these bands.

The antenna assembly 100 forms the radiating portion 50 by exposing portions of the ground plane 20 and coupling the radiating portion 50 with the feed portion 30. Because of the exposed radiating portion 50, a size of the antenna assembly 100 is small and is advantageous in the miniaturization of the wireless communication device.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna assembly, comprising:
a base board comprising a first surface and a second surface opposite to the first surface;
a ground plane, the ground plane positioned on the first surface and configured to provide ground for the antenna assembly;
a feed portion, one end of the feed portion attached to the second surface and extending to the first surface and another end of the feed portion attached to the first surface; and
a radiating portion, the radiating portion formed by removing a portion of the ground plane and coupling the removed portion with the feed portion to form a slot antenna

2. The antenna assembly of claim 1, wherein the radiating portion comprises a first exposed dielectric portion, a second exposed dielectric portion opposite and parallel to the first exposed dielectric portion, and a third exposed dielectric portion positioned between the first exposed dielectric portion and the second exposed dielectric portion, two ends of the third exposed dielectric portion are perpendicularly connected to the first exposed dielectric portion and the second exposed dielectric portion to form a substantially H-shaped closed structure.

3. The antenna assembly of claim 2, wherein the first exposed dielectric portion, the second exposed dielectric portion, and the third exposed dielectric portion are strip strip-shaped sheets, the first exposed dielectric portion and the second exposed dielectric portion are parallel and opposite to each other.

4. The antenna assembly of claim 3, wherein two ends of the first exposed dielectric portion and the second exposed dielectric portion are zigzag.

5. The antenna assembly of claim 3, wherein two ends of the first exposed dielectric portion and the second exposed dielectric portion are bent shape.

6. The antenna assembly of claim 2, wherein the antenna assembly is capable of working at a first frequency band, a second frequency band, and a third frequency band by adjusting a width of the feed portion, a length of a portion of the feed portion attached to the ground plane, a distance between the portion of the feed portion attached on the ground plane and the third exposed dielectric portion, and a length and width of the third exposed dielectric portion.

7. The antenna assembly of claim 6, wherein changing a distance between the third exposed dielectric portion and one end of the first exposed dielectric portion, a distance between the third exposed dielectric portion and another of the second exposed dielectric portion, and a distance between third exposed dielectric portion and another end of the second exposed dielectric portion is capable of adjusting bandwidths of the first frequency band, the second frequency band, and the third frequency band.

8. The antenna assembly of claim 1, wherein the base board is made of dielectric material; the ground plane is a layer of conductive foil plated on the first surface, the radiating portion is formed by hollowing the layer of the conductive foil to expose the dielectric material.

9. An antenna assembly, comprising:
a base board comprising a first surface and a second surface opposite to the first surface;
a ground plane, the ground plane positioned on the first surface and configured to provide ground for the antenna assembly;
a feed portion, one end of the feed portion attached to the second surface and extending to the first surface with another end of the feed portion attached to the first surface; and
a radiating portion, the radiating portion formed by removing a portion of the ground plane and coupling the removed portion with the feed portion to generate resonance modes at a first central frequency, a second central frequency, and a third central frequency.

10. The antenna assembly of claim 9, wherein the radiating portion comprises a first exposed dielectric portion, a second exposed dielectric portion opposite and parallel to the first exposed dielectric portion, and a third exposed dielectric portion positioned between the first exposed dielectric portion and the second exposed dielectric portion, two ends of the third exposed dielectric portion are perpendicularly connected to the first exposed dielectric portion and the second exposed dielectric portion to form a H-shaped closed structure.

11. The antenna assembly of claim 10, wherein the first exposed dielectric portion, the second exposed dielectric portion, and the third exposed dielectric portion are strip strip-shaped sheets, the first exposed dielectric portion and the second exposed dielectric portion are parallel and opposite to each other.

12. The antenna assembly of claim 11, wherein two ends of the first exposed dielectric portion and the second exposed dielectric portion are zigzag.

13. The antenna assembly of claim 11, wherein two ends of the first exposed dielectric portion and the second exposed dielectric portion are bent shape.

14. The antenna assembly of claim 10, wherein the antenna assembly is capable of working at a first frequency band, a second frequency band, and a third frequency band by adjusting a width of the feed portion, a length of a portion of the feed portion attached to the ground plane, a distance between the portion of the feed portion attached on the ground plane and the third exposed dielectric portion, and a length and width of the third exposed dielectric portion.

15. The antenna assembly of claim 14, wherein changing a distance between the third exposed dielectric portion and one end of the first exposed dielectric portion, a distance between the third exposed dielectric portion and another of the second exposed dielectric portion, and a distance between third exposed dielectric portion and another end of the second exposed dielectric portion is capable of adjusting bandwidths of the first frequency band, the second frequency band, and the third frequency band.

16. The antenna assembly of claim 9, wherein the base board is made of dielectric material; the ground plane is a layer of conductive foil plated on the first surface, the radiating portion is formed by hollowing the layer of the conductive foil to expose the dielectric material.
